(19) United States
(12) Patent Application Publication
(10) Pub. No.: US 2007/0076196 A1
(43) Pub. Date: Apr. 5, 2007

(54) SYSTEM AND METHOD FOR VISUAL INSPECTION OF WAFER

(75) Inventors: Kuo-Chung Liu, Hsinchu City (TW); Tan-Cheng Chen, Hsinchu County (TW); Ching-Sung Tai, Hsinchu City (TW); Renn-Chung Chiu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: POWERCHIP SEMICONDUCTOR CORP., Hsinchu (TW)

(21) Appl. No.: 11/458,986

(22) Filed: Jul. 20, 2006

(30) Foreign Application Priority Data
Aug. 9, 2005 (TW) 94126918

(51) Int. Cl. G01N 21/88

(52) U.S. Cl. 356/237.2

(57) ABSTRACT

A method for performing a visual inspection of a wafer is described. First, a visual inspection system for a wafer comprising at least a wafer carrying apparatus, a light source and a reflecting element is provided. The wafer carrying apparatus is used for carrying a wafer. The light source is disposed relative to the wafer carrying apparatus for illuminating the backside of the wafer. The reflecting element is disposed relative to the wafer carrying apparatus for receiving the reflection from the backside of the wafer. Then, a wafer is placed on the wafer carrying apparatus and the backside of the wafer is illuminated using the light source. Thereafter, the wafer surface and the backside of the wafer reflected to the reflecting element are inspected.

### CROSS-REFERENCE TO RELATED APPLICATION

This application claims the priority benefit of Taiwan application serial no. 94126918, filed Aug. 9, 2005. All disclosure of the Taiwan application is incorporated herein by reference.

### BACKGROUND OF THE INVENTION

1. Field of the Invention

The present invention relates to a semiconductor processing apparatus. More particularly, the present invention relates to a visual inspection system for wafer and a method of inspecting a wafer using the visual inspection system.

2. Description of the Related Art

With the rapidly developing integrated circuit technologies, millions of electronic device are packed on a tiny piece of wafer chip. To ensure the best quality, the manufacturers have developed many schedules for inspecting the surface of a wafer after various processing steps so that any defects can be remedied as soon as they are found. As the semiconductor industry steps into the deep sub-micron process regime, inspection for the backside of the wafer is getting more and more important.

Defects on the backside of a wafer mainly include, for example, scratching, adhesion of micro-particles, chipped corners and cracks, which can cause many problems. For example, the adhesion of micro-particles on the backside of the wafer may lead to some difficulties for a chuck to grab the wafer or may result in pattern defocusing in a “yellow light” (lithography) process. The scratching, the chip corners and cracks on the backside of the wafer are preliminary signs indicating some defects in the processing machines that can lead to a chain of continuous damages or breaks in the precious wafers. Therefore, if the problem machine is not found in time, the loss will expand or an entire batch of wafers will have to be scrapped. Ultimately, not only are the subsequent processing operations a waste of time, but the product yield will also drop significantly.

At present, the industry uses a special wafer inverting machine to inspect the backside of the wafer. However, the inverting machine needs time to flip over the wafer and hence lead the need for additional processing time. Thus, the time for performing a visual inspection of the entire wafer is significantly increased. Furthermore, the clamp in the inverting machine used for gripping the wafer will cover a portion of the area near the edge of the wafer so that these shielded regions no longer can be inspected. Yet, those regions are often the important areas where defects of the backside are mostly found. Thus, the conventional inverting machine often inconveniences the entire inspection operation instead.

### SUMMARY OF THE INVENTION

Accordingly, an object of the present invention is to provide a wafer inspection system having a simple design and capable of integrating with a microscope inspection stage for increasing the up time of the stage.

Another object of the present invention is to provide a method for performing a visual inspection of the front surface and the backside of a wafer at the same time without the need for using an inverting machine to flip over the wafer. Hence, the inspection time is significantly reduced and defects on the chip are more easily found. Moreover, those machines with problems are found instantaneously so that overall product yield can be increased.

To achieve these and other advantages and in accordance with the purpose of the invention, as embodied and broadly described herein, the present invention provides a wafer inspection system having at least a wafer carrying apparatus, a light source and a reflecting element. The wafer carrying apparatus is used for carrying a wafer. The light source is disposed beside the wafer carrying apparatus for illuminating the backside of the wafer. The reflecting element is disposed beside the light source and below the wafer carrying apparatus for receiving the reflection of light from the backside of the wafer.

According to an embodiment of the present invention, the light source is a light-emitting diode (LED) and the light provided by the light source is yellow light, for example.

According to an embodiment of the present invention, the wafer carrying apparatus has the capability to rotate at a rotation rate between 10˜120 rpm, for example.

According to an embodiment of the present invention, the light source and the reflecting element has the capability to revolve around the axis of the wafer carrying apparatus.

According to an embodiment of the present invention, the wafer carrying apparatus comprises a chuck suitable for suctioning a wafer, for example. Furthermore, the chuck can tilt the wafer to an angle with respect to the horizontal surface, for example. The angle of tilt between the wafer relative to the horizontal surface falls within the ±30° range, for example.

According to an embodiment of the present invention, the reflecting element includes a mirror. In addition, the wafer carrying apparatus may further include an elevator mechanism for raising or lowering the wafer.

The present invention also provides a method of inspecting a wafer. First, a wafer inspection system is provided. The wafer inspection system comprises a wafer carrying apparatus for holding a wafer, a light source for illuminating the wafer and a reflecting element for receiving the reflection from the wafer. Then, a wafer is placed on the wafer carrying apparatus and the backside of the wafer is illuminated using the light source. Thereafter, the reflection of the backside of the wafer on the reflecting element is inspected.

According to an embodiment of the present invention, the light source is a light-emitting diode (LED) and the light provided by the light source is yellow light, for example.

According to an embodiment of the present invention, the reflecting element moves relative to the wafer to inspect the backside of the wafer.

According to an embodiment of the present invention, the wafer carrying apparatus has the capability to rotate at a rotation rate between 10˜120 rpm, for example.

According to an embodiment of the present invention, the wafer carrying apparatus comprises a chuck suitable for suctioning up the wafer, for example. Furthermore, the chuck can tilt the wafer to an angle with respect to the horizontal surface, for example. The angle of tilt between the wafer relative to the horizontal surface falls within the ±30° range, for example.

In the present invention, the wafer inspection system comprising a wafer carrying apparatus, a light source and a reflecting element has a simple design. Furthermore, the wafer inspection system can combine with a microscope inspection machine. Thus, not only is the up time of the stage increased, but both the front and the backside of the wafer can also be easily inspected concurrently. In other words, the wafer inspection method can significantly reduce the inspection time and easily identify the condition at the backside of the wafer so that any problem machine that leads to a defective backside can be found instantaneously. Hence, real-time quality management on the production line can be effectively carried out to reduce process loading and increase productivity and yield.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view of a wafer inspection system according to one embodiment of the present invention.

FIG. 1B is a side view of a wafer inspection system while inspecting a wafer according to one embodiment of the present invention.

FIG. 2 is a flow chart showing the steps for inspecting a wafer according to one embodiment of the present invention.

### DESCRIPTION OF THE PREFERRED EMBODIMENTS

Reference will now be made in detail to the present preferred embodiments of the invention, examples of which are illustrated in the accompanying 5 drawings. Wherever possible, the same reference numbers are used in the drawings and the description to refer to the same or like parts.

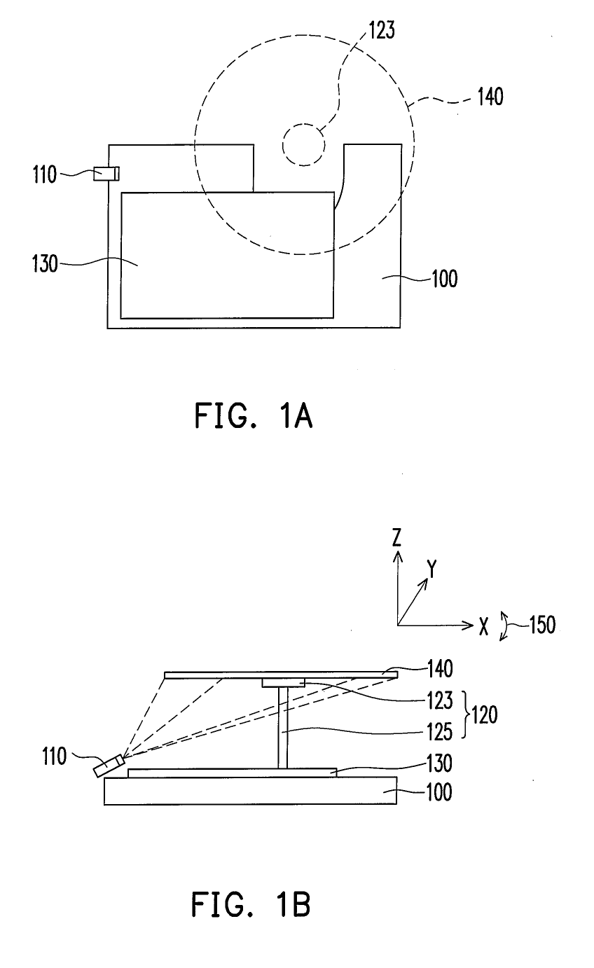

FIG. 1A is a top view of a wafer inspection system according to one embodiment of the present invention. FIG. 1B is a side view of a wafer inspection system according to one embodiment of the present invention.

As shown in FIGS. 1A and 1B, a wafer inspection system is provided. The wafer inspection system comprises a light source 110, a wafer carrying apparatus 120 and a reflecting element 130. The wafer carrying apparatus 120 is used for accommodating a wafer 140. The light source 110 is disposed in a location corresponding to the wafer carrying apparatus 120. For example, the light source 110 is set up on one side of the wafer carrying apparatus 120 for illuminating the backside of the wafer 140. The reflecting element 130 is also disposed in a location corresponding to the wafer carrying apparatus 120. For example, the reflecting element 130 is set up underneath the wafer carrying apparatus 120 for receiving a reflection of the backside of the wafer 140.

The light source 110 is a light-emitting diode, an organic light-emitting diode, a cold cathode fluorescent lamp (CCFL), a cathode ray tube (CRT), a halogen lamp or various kinds of arc lamps such as high pressure mercury lamp, metallic halide lamp, xenon lamp and so on, for example. The light source 110 provides bright visible light including yellow light or white light. In a “yellow light” (photolithography) process, a light-emitting diode capable of producing yellow light is the preferred selection because secondary exposure can be prevented even if some light leaks out and accidentally illuminates the front surface of the wafer 140.

The wafer carrying apparatus 120 and the reflecting element 130 are set up on the same inspection platform 100, for example. The reflecting element 130 is a reflecting mirror, for example. The reflecting mirror is, for example, a glass panel with a surface-coated metallic layer or metal oxide compound or a plastic reflecting material. The reflecting element 130 can also be a metallic film such as an aluminum film, a copper film or a silver film.

The wafer carrying apparatus 120 has the capability to rotate so that the wafer 140 can follow such rotation for inspecting the entire wafer 140. The rotational speed of the wafer carrying apparatus 120 is set between 10˜120 rpm, for example. In one embodiment, the reflecting element 130 has the capability to revolve around the axis of the wafer carrying apparatus 120 so that the entire backside of the wafer 140 can be inspected. Obviously, if the size of the reflecting element 130 is large enough to cover the entire backside of the wafer 140, there is no need for either the wafer 140 or the reflecting element 130 to rotate because the entire wafer backside can be inspected all at once.

The wafer carrying apparatus 120 may further include a chuck 123. The chuck 123 operates, for example, by creating a vacuum to fasten the wafer 140. Furthermore, the chuck 123 can tilt the wafer 140 relative to the horizontal surface. The wafer 140 may rotate using the X-axis as the center of rotation or using the Y-axis as the center of rotation. In FIG. 1B, the wafer 140 using the Y-axis as the axis of rotation is shown. The inclination angle 150 (the inclination angle 150 refers to the angle between the wafer 140 and the horizontal surface) is, for example, between −30°˜+30°. Using the tilting function, the inspection of the backside of the wafer 140 is simplified. In addition, the wafer carrying apparatus 120 may further includes a elevator mechanism 125 disposed between the chuck 123 and the platform 100 for raising or lowering the wafer 140 and adjusting the vertical height between the wafer 140 and the platform 100.

The foregoing wafer inspection system has a simple design and can be applied to a multitude of stages for increasing their up time. Furthermore, there is no need for an inverting machine and yet defects on the backside of the wafer can be easily identified. Thus, the present invention not only eliminate the need for equipment maintenance and reduce the wafer inspection time, but also prevent an inverting machine from shielding the edge of the wafer that render the defects on the backside of the wafer difficult to identify.

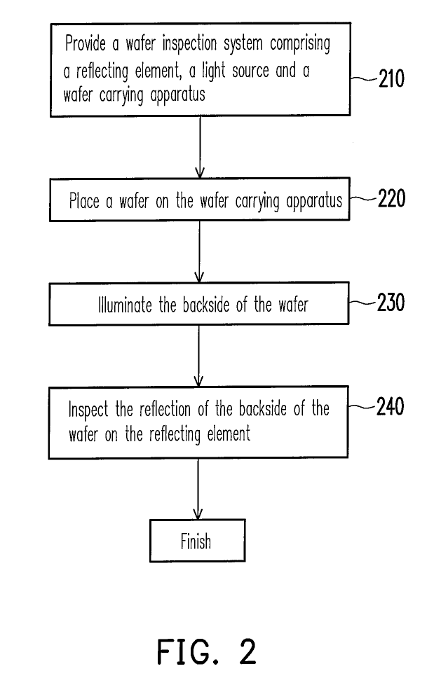

The method of inspecting a wafer is discussed in the following. FIG. 2 is a flow chart showing the steps for inspecting a wafer according to one embodiment of the present invention.

As shown in FIG. 2, a wafer inspection system is provided. The wafer inspection system comprises at least a reflecting element for receiving a reflection of the wafer, a light source for illuminating the wafer and a wafer carrying apparatus for carrying the wafer (in step 210). The wafer inspection system is the same as the ones shown in FIGS. 1A and 1B. Since the wafer inspection system and related elements have been described before, the description is not repeated here.

Then, a wafer is placed on the wafer carrying apparatus (step 220). Using the wafer carrying apparatus shown in FIGS. 1A and 1B as an example, the wafer carrying apparatus comprises a chuck for suctioning the wafer so that the wafer is firmly attached to the wafer carrying apparatus. The chuck also has the capability to tilt the wafer relative to the horizontal surface such that the inclination angle falls within the ±30° range. In addition, the wafer carrying apparatus may further include an elevator mechanism disposed between the chuck and the platform for raising or lowering the wafer and adjusting the vertical height between the wafer and the platform.

Thereafter, the backside of the wafer is illuminated using the light source (step 230). The light source is a light-emitting diode, for example. The light source includes a yellow light source, for example. Since most photolithographic processes use a yellow light process, illuminating the backside of the wafer with a yellow light source can prevent secondary exposure problem, even if some light accidentally hits the front surface of the wafer. In other words, the quality of the wafer will not be affected.

Then, the backside of the wafer reflected on the reflecting element is inspected (step 240). The reflecting element can be a mirror or a metallic film. In one embodiment, the reflecting element may not reflect the entire backside of the wafer. Therefore, the wafer and the reflecting element underneath can be made to move relative to each other so that the entire backside of the wafer can be inspected. For example, the wafer may rotate, following the rotation of the wafer carrying apparatus, at a rotational speed between about 10˜120 rpm. Alternatively, the reflecting element can be made to revolve around the wafer carrying apparatus to inspect the entire backside of the wafer. Obviously, the front surface of the wafer can also be inspected when the backside of the wafer is being inspected. In other words, the front and the back surface can be inspected simultaneously with particular ease for identifying any scratches on the backside. To prevent the light reflected from the backside of the wafer from interfering with visual inspection, both the light source and the inspector are preferably located on the same side of the wafer carrying apparatus so that the inspector can visually inspect the backside of the wafer with ease.

The wafer inspection method of the present invention utilizes the aforementioned wafer inspection system to inspect the front and the rear surface of a wafer simultaneously. Furthermore, there is no need to use an inverting machine to flip over the wafer so that the inspection time can be significantly shortened and the backside of the wafer can be inspected with ease. Hence, any problematic processing machines can be discovered instantaneously and efficiently resulting in a real-time quality management. With the discovery of any defect on the wafer back in real time rather than in subsequent processing stage, process-loading is reduced and productivity and yield are increased.

In summary, the wafer inspection system of the present invention provides a light source to illuminate the backside of a wafer, a reflecting element to receive a reflection of the backside and a wafer carrying apparatus with capabilities of rotating and changing the inclination angle. Hence, no inverting machine for wafers is required and yet can discover scratches, foreign material in the crystal boundaries, chipped corners and cracks on the backside of the wafer quickly. Consequently, time spent on finding defects on the backside of the wafer is shortened considerably. As a result, not only is any problematic machines instantly found so that real-time quality management can be implemented on the production line, but process loading is also reduced leading to a higher productivity and yield.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wafer inspection system, comprising:
a wafer carrying apparatus, used for carrying a wafer;
a light source, disposed beside the wafer carrying apparatus for illuminating the backside of the wafer; and
a reflecting element, disposed beside the light source and below the wafer carrying apparatus for receiving a reflection from the backside of the wafer.

2. The wafer inspection system of claim 1, wherein the light source comprises a light-emitting diode (LED).

3. The wafer inspection system of claim 1, wherein the light source comprises a yellow light source.

4. The wafer inspection system of claim 1, wherein the wafer carrying apparatus has the capability of rotating.

5. The wafer inspection system of claim 4, wherein the rotational speed of the wafer carrying apparatus ranges between 10˜120 rpm.

6. The wafer inspection system of claim 1, wherein the light source and the reflecting element have the capability to rotate around the axis of the wafer carrying apparatus.

7. The wafer inspection system of claim 1, wherein the wafer carrying apparatus comprises a chuck suitable for suctioning a wafer.

8. The wafer inspection system of claim 7, wherein the chuck can tilt the wafer relative to the horizontal surface.

9. The wafer inspection system of claim 8, wherein the wafer tilts relative to the horizontal surface at an inclination angle between ±30°.

10. The wafer inspection system of claim 1, wherein the reflecting element comprises a mirror.

11. The wafer inspection system of claim 1, wherein the wafer carrying apparatus further comprises an elevator mechanism for raising or lowering the wafer.

12. A method of inspecting a wafer, comprising the steps of:
providing a wafer inspection system, wherein the wafer inspection system comprises a wafer carrying apparatus for carrying a wafer, a light source for illuminating the wafer and a reflecting element for receiving a reflection from the wafer;
placing a wafer on the wafer carrying apparatus;
illuminating the backside of the wafer using the light source; and
inspecting the reflection of the backside of the wafer on the reflecting element.

13. The method of claim 12, wherein the light source comprises a light-emitting diode.

14. The method of claim 12, wherein the light source comprises a yellow light source.

15. The method of claim 12, wherein the reflecting element moves relative to the wafer in the process of inspecting the backside of the wafer.

16. The method of claim 12, wherein the wafer carrying apparatus has the capability of rotating.

17. The method of claim 16, wherein the rotational speed of the wafer carrying apparatus is between 10˜120 rpm.

18. The method of claim 12, wherein the wafer carrying apparatus has a chuck for suctioning the wafer.

19. The method of claim 18, wherein the chuck can tilt the wafer relative to the horizontal surface.

20. The method of claim 19, wherein the wafer tilts relative to the horizontal surface at an inclination angle between ±30°.
